(19) United States
(12) Patent Application Publication
(10) Pub. No.: US 2022/0144700 A1
(43) Pub. Date: May 12, 2022

(54) HIGH STRENGTH CORAL CONCRETE AND PREPARATION METHOD THEREOF

(71) Applicant: Guilin University of Technology, Guangxi (CN)

(72) Inventors: Lei Wang, Guangxi (CN); Jin Yi, Guangxi (CN); Dapeng Yu, Guangxi (CN); Rongjin Liu, Guangxi (CN)

(21) Appl. No.: 17/260,158

(22) PCT Filed: Jul. 6, 2020
(86) PCT No.: PCT/CN2020/100321

§ 371 Date: Jan. 13, 2021

(30) Foreign Application Priority Data
Jul. 24, 2019 (CN) 201910673816.3

(51) Int. Cl. C04B 14/28; C04B 28/04; C04B 14/06; C04B 18/14; C04B 24/26; B28C 5/00

(52) U.S. Cl. CPC C04B 14/28; C04B 28/04; C04B 14/06; C04B 2103/302; C04B 24/2641; B28C 5/003; C04B 18/146

(57) ABSTRACT

A method of preparing high strength coral concrete, wherein the high strength coral concrete is prepared from raw materials of the following parts by mass: 25˜63 parts of cementing materials, 45˜58 parts of coral aggregate, 10˜16 parts of mixing water and water reducer 2˜5% the weight of the cementing materials; the weighed coral aggregate, mixing water, water reducer and 55˜85% of the cementing materials are stirred in an agitator for 10˜15 minutes; the rest of cementing materials are added in batches before initial setting and stirred; then poured and removed from the mould after 24 hours, cured in mixing water at normal temperature for 28 days, to get the high strength coral concrete.

This application claims priority to Chinese Patent Application No. 2019106738163, entitled “METHOD OF PREPARING HIGH STRENGTH CORAL CONCRETE”, filed to China National Intellectual Property Administration on July the 24th, 2019, the entire contents of which are incorporated herein by reference.

### TECHNICAL FIELD

The present disclosure pertains to the technical field of architectural engineering materials, and specifically pertains to a high strength coral concrete and a preparation method thereof.

### BACKGROUND

With the gradual improvement of the infrastructure construction on the marine islands and reefs, some special island-reef constructions have high requirements on the mechanical performances of coral concrete. Without damaging the local ecological environment and maximizing the resource utilization, the high strength coral concrete prepared by using coral debris as the aggregate and using seawater instead of fresh water has great practical significance in the infrastructure construction on the islands and reefs.

However, there are many gaps and defects inside the coral aggregate, and the strength of the aggregate itself is low. Meanwhile, there are also a large number of open pores on the surface of the coral aggregate, and the surface is rough and has a high water demand Moreover, coral concrete prepared by conventional methods generally has some disadvantages such as small elastic modulus, high porosity and low strength. Therefore, even if employing rich slurry, reducing the water-binder ratio, employing treatment on the surface of aggregate, it is still difficult to solve the problems of low strength and high porosity, thus greatly limiting the further development and application of coral concrete.

Therefore, it is urgent to improve the formulation and processes of coral concrete to enhance the strength and reduce the porosity of coral concrete.

### SUMMARY

The present disclosure aims to provide a high strength coral concrete and a preparation method thereof. The coral concrete prepared by the method of the present disclosure has a significantly enhanced strength and a lower porosity.

To achieve the above objective, the present disclosure provides the following technical solution:

The present disclosure provides a method of preparing high strength coral concrete, wherein the high strength coral concrete is prepared from raw materials of the following parts by mass: 25˜63 parts of cementing materials, 45˜58 parts of coral aggregate, 10˜16 parts of mixing water and water reducer 2˜5% the weight of cementing materials;

Specific steps are as below:

(1) Weighing raw materials;

(2) Coral aggregate, mixing water, water reducer and 55˜85% of cementing materials weighed in step (1) are stirred in an agitator for 10˜15 minutes, to get first materials;

(3) The rest of cementing materials are added into the first materials obtained in step (2) in batches before initial setting and stirred, to get second materials;

(4) The second materials obtained in step (3) are poured to get test pieces;

(5) The test pieces obtained in step (4) are removed from the mould after 24 hours and cured in mixing water at normal temperature for 28 days, to get the high strength coral concrete.

Preferably, the cementing materials are composed of the components of the following parts by mass: 20˜45 parts of cement and 5˜18 parts of mineral admixtures.

Preferably, the mineral admixtures are one or more of fly ash, silica fume, slag powder, steel slag powder, phosphorous slag powder and quartz powder.

Preferably, the cement is cement commonly used in projects.

Preferably, the cement is general purpose Portland cement, special Portland cement or aluminate cement.

Preferably, the general purpose Portland cement is Portland cement, common Portland cement, slag Portland cement, Portland pozzolana cement, fly ash Portland cement or composite Portland cement.

Preferably, the coral aggregate is natural coral debris or artificially pulverized coral debris.

Preferably, the particle size of the coral aggregate is less than 10 mm.

Preferably, the fineness modulus of the coral aggregate is 2.6.

Preferably, the mixing water in step (2) is fresh water, desalinated seawater or seawater.

Preferably, the water reducer is one or more of lignin-based, naphthalene-based and resin-based high-range water reducer.

Preferably, the resin-based high-range water reducer is polycarboxylates high performance water reducer.

The present disclosure further provides a high strength coral concrete prepared by the above preparation method.

The present disclosure provides a method of preparing high strength coral concrete, wherein the high strength coral concrete is prepared from raw materials of the following parts by mass: 25˜63 parts of cementing materials, 45˜58 parts of coral aggregate, 10˜16 parts of mixing water and water reducer 2˜5% the weight of cementing materials; Specific steps are as below: Weighing raw materials; The weighed coral aggregate, mixing water, water reducer and 55˜85% of cementing materials are stirred in an agitator for 10˜15 minutes, to get first materials; The rest of cementing materials are added into the first materials in batches before initial setting and stirred, to get second materials; The second materials are poured to get test pieces; The test pieces are removed from the mould after 24 hours and cured in mixing water at normal temperature for 28 days, to get the high strength coral concrete. In the present disclosure, the components of coral concrete are optimized, cementing materials are added in batches and stirred; a large proportion of cementing materials are firstly added to increase the water-binder ratio so as to ensure good fluidity of the cement slurry, allowing it seep into the coral aggregate to fill the open pores, thus reducing the defects inside the coral aggregate, and effectively avoiding that the cementing materials with low water-binder ratio are too sticky and has low fluidity and is difficult to seep into the open pores of the coral aggregate, resulting in serious agglomeration phenomenon of fresh coral concrete; the rest of cementing materials are then added to absorb excess water in the cement slurry, reduce the water cement ratio, and enhance the interface strength; after hardening, the porosity of coral concrete decreases greatly, and the strength and anti-permeability are improved significantly. It is demonstrated from the results of embodiments that, the strength of the coral concrete prepared in the present disclosure is enhanced greatly, up to the strength grade of C70 and above, meeting the strength requirement of Technical Specification for Application of High Strength Concrete; The cross section of coral concrete is observed, showing no obvious voids and water sacs.

### DETAILED DESCRIPTION

The present disclosure provides a method of preparing high strength coral concrete, wherein the high strength coral concrete is prepared from raw materials of the following parts by mass: 25˜63 parts of cementing materials, 45˜58 parts of coral aggregate, 10˜16 parts of mixing water and water reducer 2˜5% the weight of cementing materials;

Specific steps are as below:

(1) Weighing raw materials;

(2) Coral aggregate, mixing water, water reducer and 55˜85% of cementing materials weighed in step (1) are stirred in an agitator for 10˜15 minutes, to get first materials;

(3) The rest of cementing materials are added into the first materials obtained in step (2) in batches before initial setting and stirred, to get second materials;

(4) The second materials obtained in step (3) are poured to get test pieces;

(5) The test pieces obtained in step (4) are removed from the mould after 24 hours and cured in mixing water at normal temperature for 28 days, to get the high strength coral concrete.

By mass fraction, raw materials used to prepare the high strength coral concrete of the present disclosure include 25˜63 parts of cementing materials, further preferably 30˜60 parts, and more preferably 40˜50 parts. In the present disclosure, the cementing materials are used for cementing.

By mass fraction, the components of the cementing materials include 20˜45 parts of cement, further preferably 25˜40 parts, and more preferably 30˜35 parts. In the present disclosure, the cement is preferably cement commonly used in projects, further preferably general purpose Portland cement, special Portland cement or aluminate cement. In the present disclosure, the general purpose Portland cement is preferably Portland cement, common Portland cement, slag Portland cement, Portland pozzolana cement, fly ash Portland cement or composite Portland cement. The present disclosure has no special limitation on the specific type of the special Portland cement and aluminate cement, any special Portland cement and aluminate cement well known to the persons skilled in the art can be used.

By mass fraction, the components of the cementing materials include 5˜18 parts of mineral admixtures, further preferably 10˜15 parts, and more preferably 11˜14 parts. In the present disclosure, the mineral admixtures are preferably one or more of fly ash, silica fume, slag powder, steel slag powder, phosphorous slag powder and quartz powder, more preferably fly ash and silica fume. The present disclosure has no special limitation on the particle sizes and surface areas of the mineral admixtures, any commercial mineral admixtures can be used. In the present disclosure, the fly ash significantly improves the workability of coral concrete under low water cement ratio; the silica fume effectively prevents the reaction of alkali aggregate, fills the structure of cement stone, improves the microstructure of slurry, and enhances the mechanical properties and compaction of solidified bodies.

The present disclosure has no special limitation on the sources of various components in the cementing materials, any commercial products well known to the persons skilled in the art can be used.

By mass fraction, raw materials used to prepare the high strength coral concrete of the present disclosure include 45˜58 parts of coral aggregate, further preferably 47˜55 parts, and more preferably 50˜52 parts. In the present disclosure, the coral aggregate is preferably natural coral debris or artificially pulverized coral debris. The present disclosure has no special limitation on the sources of coral aggregate, any commercial products well known to the persons skilled in the art can be used. In the present disclosure, the coral aggregate acts as a skeleton or is used for filling.

In the present disclosure, the fineness modulus of the coral aggregate is preferably 2.6. In the present disclosure, the particle size of the coral aggregate is preferably less than 10 mm, further preferably one or more discontinuous gradings in a range of less than 10 mm or one or more continuous gradings in a range of less than 10 mm, more preferably continuous gradings of 2.36˜4.75 mm, 1.18˜2.36 mm, 0.6˜1.18 mm, 0.3˜0.6 mm, 0.15˜0.3 mm, and less than 0.15 mm. The present disclosure has no special limitation on the proportion of the particle size grading range in the coral aggregate, as long as the particle sizes can be ensured to meet the requirements. In the present disclosure, the particle size gradings of the coral aggregate are adjusted so that coral aggregate with relatively small particle sizes can seep into the coral aggregate with relatively larger particle sizes to fill the open pores of the coral aggregate, further reducing the defects inside the coral aggregate and further enhancing the interface strength of hydration products of coral aggregate and cementing materials, and finally improving the mechanical performances of coral concrete significantly.

By mass fraction, raw materials used to prepare the high strength coral concrete of the present disclosure include 10˜16 parts of mixing water, more preferably 12˜15 parts. In the present disclosure, the mixing water is preferably fresh water, desalinated seawater or seawater. The present disclosure has no special limitation on the sources of the mixing water, any commercial products well known to the persons skilled in the art can be used. In the present disclosure, the mixing water is used to formulate the concrete.

By mass fraction, raw materials used to prepare the high strength coral concrete of the present disclosure include water reducer 2˜5% the weight of cementing materials, more preferably water reducer 3˜4% the weight of cementing materials. In the present disclosure, the water reducer is preferably one or more of lignin-based, naphthalene-based and resin-based high-range water reducer, more preferably polycarboxylates high performance water reducer. The present disclosure has no special limitation on the sources of the water reducer, any commercial products well known to the persons skilled in the art can be used. The present disclosure has no special requirements on the water-reducing rate of the water reducer, as long as meeting the standard of commercial water reducer.

In the present disclosure, the above raw materials for the high strength coral concrete are weighed. The present disclosure has no special limitation on the weighing operational steps, as long as ensuring the weight of the high strength coral concrete meet the requirements.

After weighing in the present disclosure, the weighed coral aggregate, mixing water, water reducer and 55˜85% of the cementing materials are stirred in an agitator for 10˜15 minutes, to get first materials. In the present disclosure, the amount of cementing materials is preferably 60˜80% of the total amount of cementing materials, further preferably 65˜75%, more preferably 70%.

The present disclosure has no special limitations on the temperature and rate of stirring, as long as ensuring the coral aggregate, mixing water, water reducer and cementing materials be mixed uniformly in the agitator within 10˜15 minutes. In the present disclosure, the stirring time is preferably 12˜15 minutes. The present disclosure has no special limitation on the model of the agitator, any agitators well known to the persons skilled in the art can be used. In the present disclosure, a large proportion of cementing materials are firstly added to increase the water-binder ratio so as to ensure good fluidity of the cement slurry, allowing it seep into the coral aggregate to fill the open pores, thus reducing the defects inside the coral aggregate, and effectively avoiding that the cementing materials with low water-binder ratio are too sticky and has low fluidity and is difficult to seep into the open pores of the coral aggregate, resulting in serious agglomeration phenomenon of fresh coral concrete.

After obtaining the first materials in the present disclosure, the rest of cementing materials are added into the first materials in batches before initial setting and stirred, to get second materials. In the present disclosure, during addition in batches, the stirring time after each addition is preferably 4˜7 min, more preferably 5˜6 min. In the present disclosure, the times of addition in batches is preferably ≥1, more preferably 1˜2 times. In the present disclosure, the time from placing the weighed coral aggregate, mixing water, water reducer and 55˜85% of the cementing materials into the agitator to adding the rest of cementing material and finishing the stirring is preferably ≤30 min. In the present disclosure, the rest of cementing materials are then added to absorb excess water in the cement slurry, reduce the water cement ratio, and enhance the interface strength; after hardening, the porosity of coral concrete decreases greatly, and the strength and anti-permeability are improved significantly.

After obtaining the second materials in the present disclosure, the second materials are poured to get test pieces. The present disclosure has no special limitation on the specific operations of pouring, any pouring operations well known to the persons skilled in the art can be used.

After obtaining the test pieces in the present disclosure, the test pieces are removed from the mould after 24 hours and cured in mixing water at normal temperature for 28 days, to get the high strength coral concrete. The present disclosure has no special limitation on the removal operations, as long as removing the cured test pieces. The present disclosure has no special limitation on the varieties of mixing water, any mixing water well known to the persons skilled in the art can be used. In the present disclosure, the mixing water is preferably fresh water or seawater. In the present disclosure, there is no correlation between the amount of the mixing water and the amount of the mixing water in the raw materials of the high strength coral concrete. The present disclosure has no special limitation on the amount of the mixing water, as long as soaking the test pieces thoroughly. The present disclosure has no special limitation on the curing operations, and the underwater curing well known to the persons skilled in the art can be used. In the present disclosure, the curing can ensure appropriate hardening conditions for the concrete to allow its strength increase continually, thus further improving durability and integrity of the concrete.

In the preparation method provided by the present disclosure, the components of coral concrete are optimized, cementing materials are added in batches and stirred; a large proportion of cementing materials are firstly added to increase the water-binder ratio so as to ensure good fluidity of the cement slurry, allowing it seep into the coral aggregate to fill the open pores, thus reducing the defects inside the coral aggregate, and effectively avoiding that the cementing materials with low water-binder ratio are too sticky and has low fluidity and is difficult to seep into the open pores of the coral aggregate, resulting in serious agglomeration phenomenon of fresh coral concrete; the rest of cementing materials are then added to absorb excess water in the cement slurry, reduce the water cement ratio, and enhance the interface strength; after hardening, the porosity of coral concrete decreases greatly, and the strength and anti-permeability are improved significantly; meanwhile, the preparation method provided by the present disclosure also solves the demand for high strength concrete on islands and reefs, in which pulverized coral aggregate of various particle sizes can be fully utilized, and the operational processes of which are simple and reliable, having obvious technical and economic benefits.

The present disclosure also provides a high strength coral concrete prepared by the above preparation method. The high strength coral concrete provided by present disclosure has excellent strength, up to the strength grade of C70 and above, meeting the strength requirement of Technical Specification for Application of High Strength Concrete; and the cross section of coral concrete is observed, showing no obvious voids and water sacs.

The method of preparing high strength coral concrete provided by the present disclosure will be illustrated in detail in combination with the following embodiments, but these embodiments should not be construed as limitation on the protection scope of the present disclosure.

### Embodiment 1

Raw materials: 40 parts of cementing materials (32 parts of Portland cement with the mark number of P·II 52.5R and 8 parts of Grade II fly ash, its density is 2700 kg/m³, the specific surface area is 450 m²/kg, the loss on ignition is 3.5%, and the water demand is 95%), 50 parts of coral aggregate (artificially pulverized coral debris, its particle size gradings are: 2.36˜4.75 mm accounting for 7.6%, 1.18˜2.36 mm accounting for 10.3%, 0.6˜1.18 mm accounting for 34.2%, 0.3˜0.6 mm accounting for 39.4%, 0.15˜0.3 mm accounting for 7.3%, coral powder of less than 0.15 accounting for 1.2%, its fineness modulus is 2.6), 12 parts of seawater and polycarboxylates high performance water reducer 4% the weight of cementing materials;

Specific steps are as below:

(1) Weighing raw materials;

(2) Coral aggregate, mixing water, water reducer and 70% of cementing materials weighed in step (1) are stirred in an agitator for 10 min, to get first materials;

(3) The rest of cementing materials are added into the first materials obtained in step (2) at one time before initial setting and stirred for a period of 7 min, to get second materials;

(4) The second materials obtained in step (3) are poured to get test pieces;

(5) The test pieces obtained in step (4) are removed from the mould after 24 hours and cured in mixing water at normal temperature for 28 days, to get the high strength coral concrete.

### Embodiment 2

Raw materials: 40 parts of cementing materials (28 parts of Portland cement with the mark number of P·II 52.5R; 8 parts of Grade II fly ash, its density is 2700 kg/m³, the specific surface area is 450 m²/kg, the loss on ignition is 3.5%, and the water demand is 95%; 4 parts of silica fume, its average particle size is 0.1 μm, and surface area is 15˜20 m²/g), 50 parts of coral aggregate (artificially pulverized coral debris, its particle size gradings are: 2.36˜4.75 mm accounting for 7.6%, 1.18˜2.36 mm accounting for 10.3%, 0.6˜1.18 mm accounting for 34.2%, 0.3˜0.6 mm accounting for 39.4%, 0.15˜0.3 mm accounting for 7.3%, coral powder of less than 0.15 accounting for 1.2%, its fineness modulus is 2.6), 12 parts of seawater and polycarboxylates high performance water reducer 4% the weight of cementing materials;

Specific steps are as below:

(1) Weighing raw materials;

(2) Coral aggregate, mixing water, water reducer and 70% of cementing materials weighed in step (1) are stirred in an agitator for 10 min, to get first materials;

(3) The rest of cementing materials are added into the first materials obtained in step (2) at one time before initial setting and stirred for a period of 7 min, to get second materials;

(4) The second materials obtained in step (3) are poured to get test pieces;

(5) The test pieces obtained in step (4) are removed from the mould after 24 hours and cured in mixing water at normal temperature for 28 days, to get the high strength coral concrete.

### Embodiment 3

Raw materials: 41 parts of cementing materials (25 parts of Portland cement with the mark number of P·II 52.5R; 8 parts of Grade II fly ash, its density is 2700 kg/m³, the specific surface area is 450 m²/kg, the loss on ignition is 3.5%, and the water demand is 95%; 8 parts of quartz powder, its grade is 600 meshes, the average particle size is 21.3 μm, and the density is 2.72 g/cm³), 49 parts of coral aggregate (artificially pulverized coral debris, its particle size gradings are: 2.36˜4.75 mm accounting for 7.6%, 1.18˜2.36 mm accounting for 10.3%, 0.6˜1.18 mm accounting for 34.2%, 0.3˜0.6 mm accounting for 39.4%, 0.15˜0.3 mm accounting for 7.3%, coral powder of less than 0.15 accounting for 1.2%, its fineness modulus is 2.6), 10 parts of seawater and polycarboxylates high performance water reducer 3% the weight of cementing materials;

Specific steps are as below:

(1) Weighing raw materials;

(2) Coral aggregate, mixing water, water reducer and 65% of cementing materials weighed in step (1) are stirred in an agitator for 10 min, to get first materials;

(3) The rest of cementing materials are added into the first materials obtained in step (2) in two batches before initial setting and stirred for a period of 5 min each time, to get second materials;

(4) The second materials obtained in step (3) are poured to get test pieces;

(5) The test pieces obtained in step (4) are removed from the mould after 24 hours and cured in seawater at normal temperature for 28 days, to get the high strength coral concrete.

### Embodiment 4

Raw materials: 41 parts of cementing materials (27 parts of Portland cement with the mark number of P·II 52.5R; 8 parts of Grade II fly ash, its density is 2700 kg/m³, the specific surface area is 450 m²/kg, the loss on ignition is 3.5%, and the water demand is 95%; 6 parts of silica fume, its average particle size is 0.1 μm, the surface area is 15˜20 m²/g), 49 parts of coral aggregate (artificially pulverized coral debris, its particle size gradings are: 2.36˜4.75 mm accounting for 7.6%, 1.18˜2.36 mm accounting for 10.3%, 0.6˜1.18 mm accounting for 34.2%, 0.3˜0.6 mm accounting for 39.4%, 0.15˜0.3 mm accounting for 7.3%, coral powder of less than 0.15 accounting for 1.2%, its fineness modulus is 2.6), 10 parts of seawater and polycarboxylates high performance water reducer 3% the weight of cementing materials;

Specific steps are as below:

(1) Weighing raw materials;

(2) Coral aggregate, mixing water, water reducer and 65% of cementing materials weighed in step (1) are stirred in an agitator for 10 min, to get first materials;

(3) The rest of cementing materials are added into the first materials obtained in step (2) in two batches before initial setting and stirred for a period of 5 min each time, to get second materials;

(4) The second materials obtained in step (3) are poured to get test pieces;

(5) The test pieces obtained in step (4) are removed from the mould after 24 hours and cured in seawater at normal temperature for 28 days, to get the high strength coral concrete.

The high strength coral concretes prepared in Embodiments 1˜4 were determined for the compressive strength, the flexural strength and the porosity, with the results being shown in Table 1.

TABLE 1
Determination results of coral concretes

| | Compressive | Flexural | |
|---|---|---|---|
| Products | Strength/MPa | Strength/MPa | Porosity/% |
| Embodiment 1 | 74.07 | 9.8 | 9.77 |
| Embodiment 2 | 82.87 | 10.5 | 9.13 |
| Embodiment 3 | 99.2 | 8.2 | 8.10 |
| Embodiment 4 | 97.4 | 8.4 | 8.40 |

It can be seen from Table 1 that, the coral concretes prepared in embodiments 1˜4 have good workability, meeting the technical requirements of concrete for projects; they can reach a strength grade of C70˜C90. Based on the definition in Technical Specification for Application of High Strength Concrete (JGJ/T 281-2012), the coral concrete prepared in the present disclosure meets the strength requirement of high strength concrete. Compared to the strength of coral concrete in the currently available documents which is mostly 20˜50 MPa, the strength of coral concrete prepared in these embodiments has been enhanced significantly, the process is simple, and it can meet the requirements of high strength concrete in civil concrete projects; Meanwhile, the porosity of the coral concrete prepared in these embodiments is reduced to 8.1˜9.77%, and its anti-permeability and durability are both improved effectively.

It can be seen from the above embodiments that, the strength of coral concrete prepared in the present disclosure is enhanced greatly, up to the strength grade of C70 and above, meeting the strength requirement of Technical Specification for Application of High Strength Concrete; The cross section of coral concrete is observed, showing no obvious voids and water sacs, indicating that its compaction degree and durability have been improved.

The description of the above embodiments is intended only to assist in understanding the method and core concept of the present disclosure. It should be noted that several improvements and modifications can be made to the present disclosure by the persons with ordinary skills in the art without deviating from the principle of the present disclosure, all of which also fall within the protection scope of claims of the present disclosure. Various modifications to these embodiments are apparent to technical personnel in the art. General principles defined herein can be realized in other embodiments without deviating from the spirit or scope of the present disclosure. Therefore, the present disclosure shall not be confined to these embodiments set forth herein, but shall conform to the widest scope consistent with the principle and novel features disclosed herein.

1. A method of preparing high strength coral concrete, wherein the high strength coral concrete is prepared from raw materials of the following parts by mass: 25˜63 parts of cementing materials, 45˜58 parts of coral aggregate, 10˜16 parts of mixing water and water reducer 2˜5% the weight of cementing materials;
Specific steps are as below:
(1) Weighing raw materials;
(2) Coral aggregate, mixing water, water reducer and 55˜85% of cementing materials weighed in step (1) are stirred in an agitator for 10˜15 minutes, to get first materials;
(3) The rest of cementing materials are added into the first materials obtained in step (2) in batches before initial setting and stirred, to get second materials;
(4) The second materials obtained in step (3) are poured to get test pieces;
(5) The test pieces obtained in step (4) are removed from the mould after 24 hours and cured in mixing water at normal temperature for 28 days, to get the high strength coral concrete.

2. The preparation method according to claim 1, wherein, the cementing materials are composed of the components of the following parts by mass: 20˜45 parts of cement and 5˜18 parts of mineral admixtures.

3. The preparation method according to claim 2, wherein, the mineral admixtures are one or more of fly ash, silica fume, slag powder, steel slag powder, phosphorous slag powder and quartz powder.

4. The preparation method according to claim 2, wherein, the cement is cement commonly used in projects.

5. The preparation method according to claim 4, wherein, the cement is general purpose Portland cement, special Portland cement or aluminate cement.

6. The preparation method according to claim 5, wherein, the general purpose Portland cement is Portland cement, common Portland cement, slag Portland cement, Portland pozzolana cement, fly ash Portland cement or composite Portland cement.

7. The preparation method according to claim 1, wherein, the coral aggregate is natural coral debris or artificially pulverized coral debris.

8. The preparation method according to claim 1, wherein, the particle size of the coral aggregate is less than 10 mm.

9. The preparation method according to claim 1, wherein, the fineness modulus of the coral aggregate is 2.6.

10. The preparation method according to claim 1, wherein, the mixing water in step (2) is fresh water, desalinated seawater or seawater.

11. The preparation method according to claim 1, wherein, the water reducer is one or more of lignin-based, naphthalene-based and resin-based high-range water reducer.

12. The preparation method according to claim 11, wherein, the resin-based high-range water reducer is polycarboxylates high performance water reducer.

13. A high strength coral concrete prepared by the preparation method of claim 1.

14. The preparation method according to claim 7, wherein the particle size of the coral aggregate is less than 10 mm.

15. A high strength coral concrete prepared by the preparation method of claim 2.

16. A high strength coral concrete prepared by the preparation method of claim 3.

17. A high strength coral concrete prepared by the preparation method of claim 4.

18. A high strength coral concrete prepared by the preparation method of claim 5.

19. A high strength coral concrete prepared by the preparation method of claim 6.

20. A high strength coral concrete prepared by the preparation method of claim 7.
